(19) United States
(12) Patent Application Publication
(10) Pub. No.: US 2022/0397215 A1
(43) Pub. Date: Dec. 15, 2022

(54) UNIVERSAL THEFT DETERRENCE DEVICE FOR CATALYTIC CONVERTERS

(71) Applicant: 3WM Inc., Ottawa (CA)

(72) Inventor: Dennis Archer, Ottawa (CA)

(73) Assignee: 3WM Inc., Ottawa (CA)

(21) Appl. No.: 17/841,503

(22) Filed: Jun. 15, 2022

(30) Foreign Application Priority Data
Jun. 15, 2021 (CA) 3121873

(51) Int. Cl. F16L 3/137; F16L 3/127

(52) U.S. Cl. CPC F16L 3/137; F16L 3/127

(57) ABSTRACT

There is provided a universal theft deterrent device for a catalytic converter. A bracket is configured to be attached to the catalytic converter using straps and a wire rope. The wire rope is connected through holes in the bracket and attached to the frame of a vehicle.

### TECHNICAL FIELD

The present application exists in the field of catalytic converter protectors. More particularly, a universal theft deterrence device is provided that is non-permanently attached to a motorised vehicle to deter the theft of the factory installed catalytic converter by increasing the complexity of removal by a thief.

### BACKGROUND

Catalytic converters in motorised vehicles are targeted by thieves due to their ease of access and high value metals. Catalytic converters are often mounted externally under the vehicle. These devices can be easily removed destructively with a battery-operated sawing device. Thieves are able to steal a catalytic converter from a vehicle in under three minutes, rendering the vehicle un-drivable and leading to a substantial repair cost to the owner.

There are devices on the market which attempt to conceal or otherwise make accessing the catalytic converter in a motorised vehicle difficult. These devices are made as customized plates or wire mesh devices that are applicable only for the model year of passenger vehicle they are designed for.

Other methods of protecting catalytic converters are difficult, customized, and expensive to install. Furthermore, these other protective methods make the repair and maintenance of catalytic converters difficult when repair is required.

### SUMMARY

In one aspect, there is provided a universal theft deterrent device for a catalytic converter comprising a bracket configured to be attached to the catalytic converter and a wire rope connected to the bracket and configured to be attached/threaded through or wrapped around the frame of a vehicle.

In another aspect, there is provided a universal theft deterrent device comprising: a bracket; at least one strap configured to be wrapped around a catalytic converter, thereby attaching the bracket to the catalytic converter; and a wire rope for connecting the bracket to a frame of a vehicle.

In a further aspect, there is provided a wire rope that fits through holes in the bracket and is secured at each end of the wire rope to prevent the wire rope from slipping out of the holes.

In yet a further aspect, there is provided a second bracket with a second set of straps connecting the second bracket to the frame of the vehicle; wherein the wire rope is fed from the first bracket attached to the catalytic converter through holes in the second bracket, thereby attaching the wire rope to the frame of the vehicle via the second bracket.

In yet a further aspect, the bracket is comprised of a first piece and a second piece. The first piece and the second piece each have at least two elongated holes. In addition, the first piece and the second piece can each have a slot for the at least one strap to pass through. The at least two elongated holes in the first piece and the second piece are aligned such that the holes in the bracket become smaller than the two elongated holes when the first piece and the second piece are fit together to form the bracket.

### BRIEF DESCRIPTION OF THE DRAWINGS

The invention will be further understood from the following description with reference to the attached drawings.

FIG. 1 illustrates a schematic of the theft deterrent device including a bracket, two straps, and a wire rope, with the wire rope coupled to the frame of a vehicle.

FIG. 2 illustrates the components of FIG. 1 separately.

FIG. 3 illustrates the bracket.

### DETAILED DESCRIPTION

A preferred embodiment of the present invention will be set forth in detail with reference to the drawings, in which like reference numerals refer to like elements or method steps throughout.

In one aspect there is a provided a theft deterrent system that hinders a thief from quickly removing a catalytic converter, thereby increasing the time to remove the catalytic converter from the vehicle and increasing the likelihood of being discovered and caught. In one example, a metal device, such as a bracket, is non-permanently attached to a catalytic converter in a motorised vehicle. The metal device is attached to the sub-frame of the vehicle chassis using metal wire rope. The system is universal and will fit on any catalytic converter without modification to the device, the catalytic converter, or the vehicle frame. In yet a further example, a bracket is attached to the catalytic converter and one end of a wire rope is attached to the bracket, threaded through or coupled to the sub-frame of the vehicle and terminated back on the bracket.

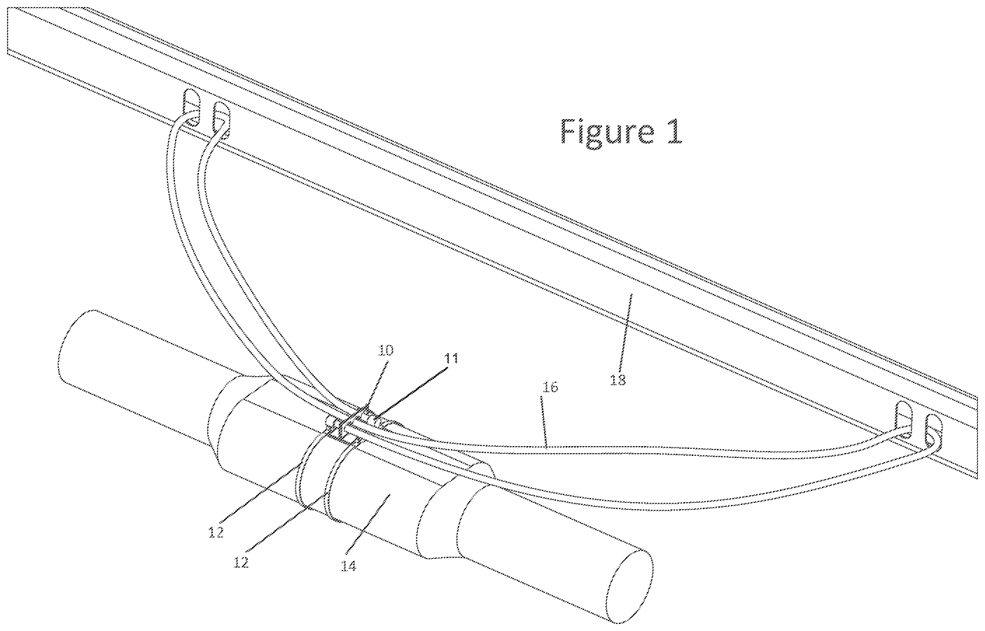

FIG. 1 shows an example embodiment wherein the theft deterrent device includes a bracket 10 with straps 12 that wrap around the catalytic converter 14. The ends of a wire rope 16 fit through holes in the bracket 10 and the wire rope 16 loops through holes in the frame 18 of the vehicle. It will be appreciated that the wire rope could also be attached to the vehicle via other means such as looping around a portion of the frame of the vehicle rather than feeding or threading through holes in the frame. The ends of the wire rope 16 feed through elongated holes in the bracket 10 and are terminated with a ferrule 11 preventing the wire rope 16 from slipping out of the bracket once installed.

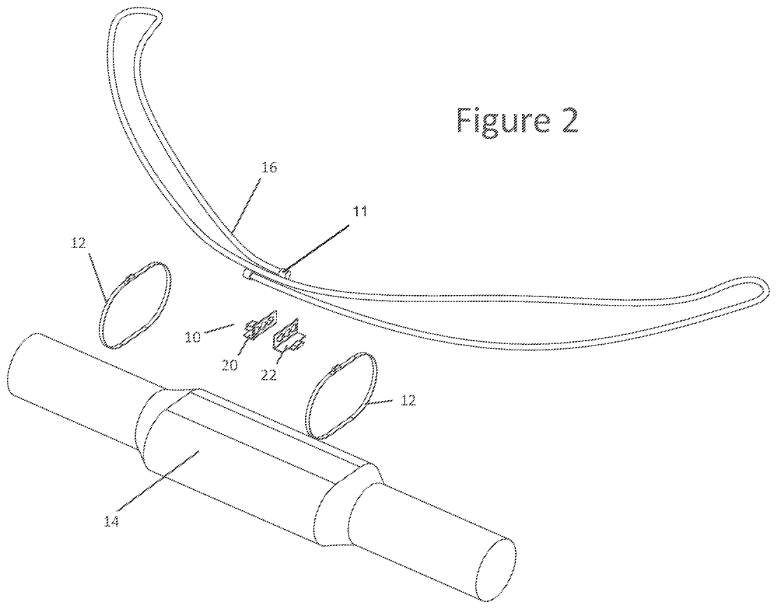

FIG. 2 shows an example embodiment of separate portions of the theft deterrent device. In this embodiment, the wire rope 16 has a ferrule 11 attached to each end thereof. The bracket 10 is formed of two pieces 20, 22 and each piece is configured with a slot to hold a strap 12. The straps 12 are extendable and can change size to fit around any size of catalytic converter 14. The size and shape of catalytic converter 14 shown in the drawings is for example purposes only.

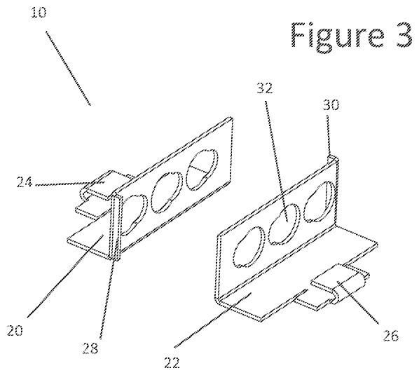

FIG. 3 shows one example embodiment of the bracket 10. In this embodiment, the bracket 10 is formed of two pieces 20, 22 and each piece has a slot 24, 26 which is configured to fit a strap 12 within each slot, holding each strap in place on each side of the bracket. Each piece 20, 22 of the bracket has a tab 28, 30 at each end to lock the two pieces together once assembled with the other components of the theft deterrent device. Each piece 20, 22 of the bracket also has two, three or more elongated holes 32 that are shaped to fit the ferrule 11 from the wire rope therein. Once the ferrule 11 passes through the holes 32 in the pieces 20, 22 of the bracket 10, the pieces 20, 22 of the bracket 10 are fit or slid together such that each of the tabs 28, 30 touches an end of the opposite bracket. Straps 12 can be slid through the slots 24, 26 and wrapped around the catalytic converter before being tightened. Once fit together, the holes in the assembled bracket 10 become circular or smaller in shape rather than elongated in shape, such that the ferrule 11 from the wire rope can no longer slide through the holes in the bracket 10, thereby keeping the wire rope in place. The bracket is locked in place via the straps 12 that are fed through the slots 24, 26 and wrapped around the catalytic converter, along with the tabs 28, 30 that are mated when the bracket is assembled with the wire rope. In one example, the elongated holes are 17.5 mm while the assembled smaller holes are only 11.1 mm which is not big enough for the ferrule to pass back through.

In one example embodiment, the bracket of the theft deterrent device may be manufactured from 304 Stainless Steel Sheet Stock, and powder coat painted in a bright colour. The bracket may be cut from sheet stock and bent into shape, forming a strong bracket that can be attached to a catalytic converter. The product can be manufactured of any suitable, strong, corrosion resistant metal with a temperature rating suitable for installation in direct contact with a catalytic converter. In a further example embodiment, the wire rope may be formed of stainless steel.

During assembly, the bracket pieces 20, 22 are separate. One end of the wire rope is fed through the first hole in each piece 20, 22, wrapped around or through the vehicle frame, fed back through the second hole in each piece, wrapped around or through the vehicle frame a second time, and fed through the third hole in each piece. The bracket pieces are then slid together so the tabs 28, 30 touch the ends of the opposite bracket piece. Straps 12 are then through the slots 24, 26 and around the catalytic converter before being tightened in place.

It will be appreciated by one skilled in the art that variants can exist in the above-described arrangements and applications. For example, any other materials and arrangement that allow for a wire-rope connection between the bracket or vehicle catalytic converter and the frame of the vehicle could be considered. Other forms and shapes of the bracket for attachment to the catalytic converter would be suitable. The wire rope can be looped through and/or around any portion of the vehicle or vehicle frame. The gauge of the wire rope can vary depending upon the user's desires for strength and attachment to the vehicle frame.

Furthermore, a second bracket and second set of straps could be used to hold the wire rope to the vehicle frame, if desired, the second set of straps used to secure the second bracket to a portion of the vehicle or vehicle frame. In this example, the wire rope is fed from the first bracket attached to the catalytic converter to the second bracket that is attached to the vehicle frame. The wire rope is fed through the elongated holes in the pieces of each bracket. The wire rope could be terminated with one end on each bracket. Alternatively, the wire rope could be fed from the first bracket, through the second bracket and terminated back at the first bracket. Any variation of looping of the wire rope could be considered; multiple passes of the wire rope between the holes in the first bracket and the holes in the second bracket will increase the strength and complexity of removing the theft deterrent device.

In another variation, additional attachment of the bracket and/or straps to the catalytic converter can be made through any suitable attachment mechanism, such as screws, bolts, straps, glue etc. Similarly, the straps may optionally be connected to the bracket through other mechanisms, such as tabs, slots or blades on the bracket. As another example, the bracket can be formed integrally with the straps.

In yet a further example, the bracket may have only two holes instead of three holes. As shown in the example embodiment of FIG. 1, when three holes are used the wire rope passes through the first hole, around the vehicle frame, through the second hole, around the vehicle and back through the third hole. In an embodiment with only two holes in the bracket, the wire rope passes through the first hole, around the vehicle and back to the bracket, terminating through the second hole.

It will be appreciated that the wire rope can be a single rope or two or more ropes connected at multiple places to the theft deterrent bracket. For example, if two ropes are used, the bracket can have four holes and each wire rope can each begin and terminate in a pair of holes.

It will further be appreciated that the wire rope can be provided with a ferrule or the ferrule can be added to the wire rope after the wire rope is fed or threaded through the bracket and around the vehicle frame.

Following from the above description, it should be apparent to those of ordinary skill in the art that, while the methods and apparatuses herein described constitute exemplary embodiments of the present invention, the invention described herein is not limited to any precise embodiment and that changes may be made to such embodiments without departing from the scope of the invention as defined by the claims. Consequently, the scope of the claims should not be limited by the preferred embodiments set forth in the examples but should be given the broadest interpretation consistent with the description as a whole. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A universal theft deterrent device comprising:
a T-shaped bracket comprising at least two elongated holes on a vertical portion and two slots on a horizontal portion;
two straps; and
a wire rope;
wherein the two slots in the bracket are each configured to receive one of the straps therethrough;
wherein the wire rope fits through the holes in the bracket and each end of the wire rope is secured to prevent the wire rope from slipping out of the holes.

2. The device of claim 1 wherein the wire rope is configured to connect the bracket to a frame of a vehicle.

3. The device of claim 1 wherein the straps are configured to wrap around a catalytic converter.

4. The device of claim 1 wherein the bracket comprises three elongated holes.

5. The device of claim 1 wherein the wire rope further comprises ferrules on each end to secure each end of the wire rope and prevent the wire rope from slipping out of the holes.

6. The device of claim 1 wherein the bracket comprises a first piece and a second piece; and wherein the first piece and the second piece each comprise the at least two elongated holes and one of the two slots.

7. The device of claim 6 wherein the elongated holes in the first piece and the second piece are aligned such that openings of the elongated holes in the bracket become smaller when the first piece and the second piece are fit together to form the bracket.

8. The device of claim 7 wherein the wire rope is configured to be fed through the elongated holes in the first piece and the second piece and wrapped around the frame of a vehicle.

9. The device of claim 7 wherein the wire rope is fitted with ferrules on each end to secure each end of the wire rope after the wire rope is fed through the elongated holes in the bracket.

10. The device of claim 7 wherein the wire rope further comprises ferrules on each end to secure each end of the wire rope and wherein the ferrules are configured to fit through the elongated holes in the first piece and the second piece.

11. The device of claim 6 wherein each of the first piece and the second piece further comprise a tab on the vertical portion to lock the two pieces together when the first piece and the second piece are fit together to form the bracket.

12. The device of claim 3 further comprising a second bracket and a second set of straps to secure the wire rope to a vehicle frame, wherein the second set of straps are configured to wrap around a portion of the vehicle frame and the wire rope is configured to fit through elongated holes in the second bracket.

13. The device of claim 1 wherein the wire rope comprises two or more pieces of rope and the bracket comprises a pair of elongated holes for each piece of rope.
